(19) United States
(12) Patent Application Publication
(10) Pub. No.: US 2005/0255034 A1
(43) Pub. Date: Nov. 17, 2005

(54) Process for producing narrow platelet graphite nanofibers

(76) Inventors: Haiyou Wang, Westboro, MA (US); R. Terry K. Baker, Hopkinton, MA (US)

Correspondence Address: Henry E. Naylor;Kean, Miller, Hawthorne,, D'Armond, McCowan & Jarman, L.L.P., P.O. Box 3513, Baton Rouge, LA, 70821-3513, US

(21) Appl. No.: 10/846,738

(22) Filed: May 14, 2004

(51) Int. Cl. C01B 31/04

(52) U.S. Cl. 423/448

(57) ABSTRACT

A catalyst composition useful for the generation of narrow width “platelet” graphite nanofibers from methane, which catalyst composition is represented by Ni_{X}Cu_{Z}Mg_{Y}O. This invention also relates to a process for producing such narrow width platelet graphite nanofibers using said catalyst composition.

### FIELD OF THE INVENTION

The present invention relates to a catalyst composition useful for the generation of narrow width “platelet” graphite nanofibers from methane, which catalyst composition is represented by Ni_{X}Cu_{Z}Mg_{Y}O. This invention also relates to a process for producing such narrow width platelet graphite nanofibers using said catalyst composition.

### BACKGROUND OF THE INVENTION

“Platelet” graphite nanofibers are defined as graphitic nanofibers in which the graphite sheets constituting the structures are stacked in a direction substantially perpendicular to the longitudinal axis of the nanofiber in an arrangement similar to that of a “deck of cards”. These types of nanofibers are finding applications in a wide variety of fields. Baker et al. U.S. Pat. No. 6,485,858 teaches the use of “platelet” graphite nanofibers for electrodes in an electrochemical fuel cell onto which noble metals, such as Pt, Pd, Ru, Ir and mixtures thereof are dispersed. In another application, Baker et al. U.S. Pat. No. 6,503,660 B2 teaches the use of “platelet” graphite nanofibers for anodes in lithium ion secondary batteries. Other published works have taught that dispersion of various metals onto “platelet” graphite nanofibers offers the opportunity to control the structure of the supported particles and induce major changes in their catalytic performance. A number of studies have focused on the modifications in both particle morphology and catalytic performance brought about by supporting metal crystallites on graphite nanofibers. (Examples include, Rodriguez et al. 1994, Hoogenraad et al. 1995, Park et al. 1998, Pham-Huu et al. 2000) Experiments performed with nickel particles supported on “platelet’ graphite nanofibers showed that such systems exhibited unusual properties with regard to selectivity patterns obtained for the hydrogenation of olefins and diolefins when compared to the behavior found when the same metal was dispersed on conventional support media, such as alumina, silica and active carbon.

Recently, it was disclosed in co-pending U.S. patent application Ser. No. 10/712,247 which is incorporated herein by reference, that it is unexpected that “platelet” graphite nanofibers can function as catalysts themselves, without the addition of a catalytically active metal phase. It was shown that these materials were capable of catalyzing the reaction of CO₂ and H₂ to produce CO and H₂O. In a further set of experiments it was found that the “platelet” graphite nanofibers were active for the dissociation of N₂O into N₂ and O₂. Also, the same materials were found to function as excellent catalysts for the oxidative dehydrogenation of ethylbenzene to styrene.

U.S. Pat. No. 6,537,515 B1 also to Baker et al. teaches a method for the production of “platelet” graphite nanofibers. The method comprises the interaction of a mixture of CO and H₂ using an iron-copper bimetallic bulk catalyst at temperatures from about 550 to about 670° C. for an effective amount of time. While such a method generates high quality “platelet” graphite nanofibers, the yields are relatively low. Furthermore, the resulting, structures possess a relatively large average width of about 110 nm and a surface area of only about 78 m²/g. In order for such carbon nanostructures to reach their full commercial potential it is essential that the efficiency of the growth process be improved. In addition, to achieve optimum performance the nanostructures must possess a narrow width in order to increase the rate of diffusion processes. This feature will enable a higher rate of charging and discharging when the nanostructures are used for the anode in a Li-ion secondary battery. In other applications, it is necessary to produce a “platelet” nanofiber configuration that exhibits high surface area in order to optimize the number of active edge sites for use as catalysts and to achieve maximum dispersion of a supported metal phase when the materials are used as support media. Therefore, there remains a need for a method by which one can increase the yield and obtain “platelet” graphite nanofibers that are substantially narrower in width and that possess a higher surface area than similar materials synthesized by conventional methods.

### SUMMARY OF THE INVENTION

In accordance with the present invention, there is provided substantially crystalline graphite nanofibers comprised of graphite sheets that are substantially perpendicular to the longitudinal axis of the nanofibers, wherein the distance between the graphite sheets is from about 0.335 nm to about 0.67 nm, having a crystallinity greater than about 95%, an average width from about 33 to about 75 nm and a surface area from about 110 to about 250 m²/g.

In a preferred embodiment, the distance between the graphite sheets is from about 0.335 to 0.40 nm, the average width of the nanofiber is from about 33 to about 55 nm, and the surface area is from about 130 to about 250 m²/g.

Also in accordance with the present invention, there is provided a process of producing substantially crystalline “platelet” graphite nanofibers possessing a narrow width and high surface area, which process comprises reacting methane in the presence of a Ni—Cu/MgO powdered catalyst for an effective amount of time from about 600 to about 800° C., preferably from about 625 to 760° C. and most preferably from 665 to 700° C.

In another preferred embodiment, the Ni to MgO ratio is typically from about 0.6:1 to about 3.6:1 and preferably from about 1.8:1 to about 3.6:1 and more preferably about 2.4:1 and the Ni to Cu ratio is from about 9:1 to 1:1, preferably from about 4:1 to about 3:2.

### DETAILED DESCRIPTION OF THE INVENTION

The graphite nanofibers of the present invention possess a structure in which the graphite sheets constituting the material are aligned in a direction that is substantially perpendicular to the fiber growth axis (longitudinal axis), similar in arrangement to that of a “deck of cards”. These types of nanofibers are frequently referred to as “platelet” graphite nanofibers. In addition, the nanofibers have a unique set of properties, which include: (i) an average width from about 33 to 75 nm, preferably from about 33 to 55 nm; (ii) a nitrogen adsorption surface area from about 130 to 250 m²/g; (iii) a crystallinity from about 95% to 100%; (iv) a spacing between adjacent graphite sheets of 0.335 nm to about 0.67 nm, preferably from about 0.335 nm to about 0.40 nm.

The catalysts used to prepare the graphite nanofibers of the present invention are nickel-copper/magnesium oxide tri-component systems in powder form. It is well established that the ferromagnetic metals, iron, cobalt and nickel, are active catalysts for the growth of graphite nanofibers during the decomposition of certain hydrocarbons or carbon monoxide. The addition of copper and magnesium oxide to these metals produces major perturbations in both the catalytic activity and the structure of the resulting graphite nanofibers formed when such systems are heated in the presence of a carbon-containing gas mixture.

The average powder particle size of the catalyst will range from about 50nm to about 5 microns, preferably from about 250 nm to about 1 micron. The ratios of Ni to Cu and both metals to magnesium oxide can be any effective ratios that will produce substantially crystalline graphite nanofibers in which the graphite sheets are substantially perpendicular to the longitudinal fiber axis, and which are characterized as having: an average width of the nanofibers less than about 75 nm, preferably less than about 65 nm, and more preferably from about 33 nm to about 55 nm; and a surface area from about 115 m²/g to 250 m²/g, preferably from about 130 to 250 m²/g when the catalyst is heated from about 600 to about 800° C., preferably from about 625 to 760° C. and most preferably from 665 to 700° C. in methane. The ratio of Ni to Cu will typically be from about 9:1 to 1:1, preferably from about 4:1 to about 3:2. The ratio of Ni to magnesium oxide is from about 0.6: 1 to about 3.6:1, preferably from about 1.8:1 to about 3.6: 1, and more preferably 2.4:1 Such catalysts can be represented by Ni_{X}Cu_{Z}Mg_{Y}O, where X, Z, and Y will vary to be within the above ranges.

Catalysts of the present invention can be prepared by the co-precipitation method. Such a method involves the co-precipitation of aqueous solutions of nickel, copper and magnesium salts with a basic aqueous solution. Non-limiting examples of nickel, copper and magnesium salts include nitrates, acetates, chlorides and sulfates. Non-limiting examples of the basic aqueous solutions include those containing NH₄OH, NaOH, KOH, Na₂CO₃ and K₂CO₃. The co-precipitated hydroxides or carbonates are left overnight, then washed in distilled water, filtrated and dried, preferably at a temperature from about 110° C. to abut 130° C. in air. The resulting dried powder is then calcined, ground to a particle size less than about 2 microns and reduced in hydrogen prior to use.

Another preferred method for preparing catalysts of the present invention is by the thermal crystallization of a supersaturated solution. Such a method is outlined below:

Step 1: A mixture of nickel nitrate, copper nitrate and magnesium nitrate in the desired ratios is initially dissolved in ethanol to form a substantially homogeneous solution.

Step 2: The solution is then subjected to evaporation to form a concentrated solution with vigorous stirring at room temperature.

Step 3: The evaporation process is continued as the temperature is raised to about 150° C. while simultaneously maintaining the stirring action until a solid mass of homogeneously mixed nitrates is obtained.

Step 4: The solid mass of mixed salts is then calcined in flowing air at a suitable calcinations temperature, preferably at about 500° C. for an effective period of time. This effective period of time will typically be from about 2 to 6 hours, preferably from about 3 to 5 hours and more preferably about 4 hours in order to convert the metal salts to the respective metal oxides.

Step 5 The metal oxides are then ground in a suitable grinding device, preferably in a ball mill to form a fine powder.

Step 6: The fine powder is then reduced in a hydrogen-containing atmosphere, most preferably one containing at least about 10 vol. %, more preferably at least about 25 vol. % hydrogen with the remainder being an inert gas, preferably argon at temperature from about 500° C. to about 1200° C. for in effective amount of time, for example for about 1 hour. These conditions are sufficient to convert at least a portion, preferably substantially all, of the nickel and copper oxides to the metallic state whereas the magnesium component remains in the oxide form.

The resulting catalysts of the present invention can be characterized as having a substantially higher percentage of active Ni sites when compared with conventional NiMgO and NiCuMgO catalysts. Active Ni sites are those Ni sites wherein the Ni atom is in a reduced or metallic state. That is, those Ni atoms that are at the surface of the catalyst and available to react with methane and that are in the bulk of the catalyst and function as a medium for carbon diffusion.

During the calcination step, the Ni²⁺, Mg²⁺ and Cu²⁺ will be converted to metal oxides, while the anions of these salts, e.g. NO³⁻ will be transformed into gaseous products e.g. NO₂, and as a consequence, will be released from the catalyst sample.

During the reduction step, all or a certain fraction, of nickel and copper will be converted into the respective metallic states. On the other hand, the magnesium species will remain in the oxide state.

Catalyzed Decomposition of Methane

It has unexpectedly been found by the inventors hereof that the catalysts of the present invention are capable of producing substantially carbon oxide-free hydrogen and substantially pure carbon by the decomposition of methane over a relatively low temperature range of 475° to 800° C. The pure carbon is most preferably in the form of the narrow width “platelet” graphite nanostructures of this invention. Conventional catalysts of similar composition can only exhibit activity for substantially CO-free hydrogen and substantially pure carbon by the direct decomposition of methane at lower temperatures (typically less than 650° C.). The catalysts of the present invention, which contain a higher level of active Ni-sites then conventional Ni-containing catalysts, are unexpectedly capable of a extending lifetime as well as substantially higher hydrogen and carbon yields, even at higher reaction temperatures, e.g. greater than 700° C., when compared with prior art catalysts.

The methane flow rate can range from about 30 to 180 ml/min; however, if one desires to obtain a high yield of hydrogen/hour, then a flow rate of about 120 ml/min is preferred.

It is within the scope of this invention that natural gas be used in place of, or as a mixture with methane, for the production of hydrogen and carbon. The presence of ethane and other C₃ to C₆ hydrocarbons in natural gas will not lead to the production of CO, or CO₂. They may, however, exert a minor effect on the lifetime of the catalyst since they undergo decomposition in a more facile manner than methane, which could give rise to premature deactivation of the catalyst. It understood, however, that such impurities are generally present in very low concentrations (typically about 2 mole % and less) in natural gas and at such low levels are unlikely to cause substantial negative effects in the behavior of the catalyst compared to that observed with pure methane feed.

The Ni and Cu components of the catalyst of the present invention will typically contain a thin layer of metal oxide coating resulting from exposure to air. Therefore, before the catalyst is used for methane decomposition, the thin oxide layer will need to be removed, preferably by heating at an effective reduction temperature in hydrogen. If the catalyst is used in the methane decomposition reaction without first removing the oxide layer it will provide lower yields of carbon and hydrogen. As a consequence, the catalyst will not be in a preferred state to perform its desired role. The catalyst of the present invention will preferably be used in a powdered form having an average particle size less than about 40 nm. When the catalyst is in a preferred state, preferably one represented by Ni_{X}Cu_{Z}Mg_{Y}O, higher yields of CO-free hydrogen and pure carbon nanofibers can be achieved by the practice of the present invention when compared with what can be achieved by conventional methods.

The present invention will be illustrated in more detail with reference to the following examples, which should not be construed to be limiting in scope of the present invention.

### EXAMPLES

The decomposition of methane was carried out in a quartz flow reactor heated by a Lindberg horizontal tube furnace. The gas flow to the reactor was precisely monitored and regulated by the use of MKS mass flow controllers allowing a constant composition of feed to be delivered. Powdered catalyst samples (50 mg) were placed in a ceramic boat at the center of the reactor tube in the furnace and the system was flushed with argon for 0.5 hours. After reduction of the sample in a 10%H₂/Ar mixture at a temperature between 500 and 1000° C., the system was once again flushed with argon and methane was introduced into the reactor and allowed to react with the catalyst at the desired temperature under atmospheric pressure conditions. The progress of the reaction was followed as a function of time by sampling both the inlet and outlet gas streams at regular intervals and analyzing the reactants and products by gas chromatography. The total amount of solid carbon deposited during the time on stream was determined gravimetrically after the system had been cooled to room temperature. This solid product was shown to be comprised of graphite nanofibers without any other forms of carbon present.

Samples of the solid carbon product were subsequently characterized by a variety of techniques including high-resolution transmission electron microscopy, which enabled the determination of the structural and physical details of the nanofibers from lattice fringe images. X-ray diffraction analysis gave information on the degree of crystalline perfection and the spacing between adjacent graphite sheets constituting the material. Surface area measurements of the nanofibers were determined by N₂ adsorption at −196° C.

### Example 1

A comparison is given in Table 1 below of the respective yields, physical and structural characteristics of “platelet” graphite nanofibers (GNF) grown from the decomposition of CH₄ over Ni_{X}Cu_{Z}Mg_{Y}O (x:y=2.4:1)(x:z=3:1) at 665° C., compared with similar materials synthesized from the interaction of Cu—Fe (3:7) with CO/H₂ at the same temperature. The reaction was allowed to continue until catalyst activity dropped to below 5%.

TABLE 1

| | | Average | d- | Surface |
|---|---|---|---|---|
| Catalyst/Reactant | GNF Yield | Width | spacing¹ | Area |
| System | (g-C/g-Cat) | (nm) | (nm) | (m²/g) |
| Ni_{X}Cu_{Z}Mg_{Y}O—CH₄ | 381 | 38.0 | 0.3409 | 221 |
| Cu—Fe (3:7)—CO/H₂(4:1) | 42 | 110.0 | 0.3371 | 117 |

¹d-spacing refers to the distance between graphite sheets (platelets) of the graphite nanofibers.

The above data reveals that by using the catalyst system of the present invention one can synthesize “platelet” graphite nanofibers having a significantly narrower width than those grown from a conventional Fe—Cu catalyst. It is also evident that the van der Waals forces are weaker as width of the structures decreases and as a consequence, the spacing between adjacent graphite layers increases. The smaller dimensions of the nanofibers generated from the catalyst system of the present invention is also reflected in an increase in surface area.

### Example 2

This set of experiments was carried out by passing 60 ml/min of CH₄ over the Ni_{X}Cu_{Z}Mg_{Y}O (x:y=2.4:1)(x:z=3:1) catalyst at temperatures from 625 to 800° C. The catalyst was prepared under the same conditions as those described in Example 1 above. Once again, reactions were allowed to proceed until the catalyst activity dropped below 5%. Examination of the results presented in Table 2 below demonstrate that as the reaction temperature is progressively raised from 625 to 800° C. the percent of CH4 that is converted per unit time increases while the lifetime of the catalyst exhibits a drop with increasing reaction temperature. There exists an optimum temperature to provide the highest yield of “platelet” graphite nanofibers. Furthermore, as the temperature is gradually increased the average width of the nanofibers increases. Clearly, the optimum conditions to produce the highest yield of narrow width nanofibers is about 665° C. for this particular catalyst system.

TABLE 2

| Reaction | | | GNF | Surface | d- | Average |
|---|---|---|---|---|---|---|
| Temp | % CH₄ | Lifetime | Yield (g- | Area | spacing | Width |
| (° C.) | Conv. | (hr) | C/g-Cat) | (m²/g) | (nm) | (nm) |
| 625 | 19.1 | 46 | 290 | 264 | 0.3404 | 32 |
| 665 | 28.5 | 38 | 381 | 221 | 0.3409 | 38 |
| 700 | 37.1 | 26 | 340 | 178 | 0.3398 | 47 |
| 725 | 44.3 | 20 | 276 | 136 | 0.3396 | 61 |
| 750 | 50.7 | 14 | 198 | 118 | 0.3391 | 71 |
| 760 | 51.7 | 12 | 170 | 103 | 0.3391 | 81 |
| 775 | 56.7 | 7 | 118 | 83 | 0.3393 | 101 |
| 800 | 54.3 | 2 | 28 | 68 | 0.3396 | 123 |

### Example 3

In this series of experiments, the effect of changing the Ni:Cu ratio in the Ni_{X}Cu_{Z}Mg_{Y}O (x:y=2.4:1) catalyst on the yield and characteristics of the “platelet” graphite nanofibers was investigated. All catalyst samples were prepared using the thermal crystallization of supersaturated solution method, previously described herein. They were calcined at 500° C., reduced in 10% H₂/He at 850° C. and reacted in 60 ml/min flowing CH₄ at 665° C. Reactions were again allowed to proceed until the activity dropped below 5%.

TABLE 3

| | % CH₄ | Lifetime | GNF Yield | Surface Area | d-spacing | Average Width |
|---|---|---|---|---|---|---|
| Ni:Cu | Conv. | (hr) | (g-C/g-Cat) | (m²/g) | (nm) | (nm) |
| 19:1 | 40.2 | 3 | 27 | 113 | 0.3401 | 74 |
| 9:1 | 35.6 | 39 | 378 | 152 | 0.3384 | 55 |
| 17:3 | 33.3 | 43 | 414 | 190 | 0.3401 | 44 |
| 4:1 | 30.6 | 43 | 427 | 194 | 0.3401 | 43 |
| 3:1 | 28.8 | 40 | 376 | 216 | 0.3389 | 39 |
| 7:3 | 27.1 | 35 | 328 | 214 | 0.3391 | 39 |
| 3:2 | 24.7 | 30 | 242 | 244 | 0.3391 | 34 |
| 1:1 | 23.0 | 28 | 198 | 250 | 0.3401 | 33 |

The data presented in Table 3 shows that there is a preferred catalyst composition window ranging from a Ni:Cu ratio of 17:3 to 7:3, over which high yields of preferred narrow width “platelet” graphite nanofibers can be generated.

### Example 4

In this series of experiments the yields and characteristics of “platelet” graphite nanofibers generated from the interaction of Ni_{X}Cu_{Z}Mg_{Y}O (x:y=2.4:1)(x:z=(3:1) and CH₄ at 665° C. were compared to those produced from various Fe/MgO—CO/H₂ (4:1) systems at 600° C. This latter temperature was previously shown to be the optimum level for the production of graphite nanofibers from a Fe-based catalyst system (See Baker et al. U.S. Pat. No. 6,537,515 which is incorporated herein by reference). The data presented in Table 4 below shows a comparison of the yield and dimensions of the resulting “platelet” graphite nanofibers generated from the supported Fe catalysts with those generated from the Cu—Ni/MgO system of the present invention. Inspection of the results clearly demonstrates that the performance of the catalyst of the present invention is superior and in addition, produces narrower “platelet” graphite nanofiber structures than any of the heavily loaded Fe/MgO catalysts.

TABLE 4

| | | GNF Yield | Surface | d- | Average |
|---|---|---|---|---|---|
| | | (g-C/g- | Area | spacing | Width |
| Catalyst | Reactant | Cat) | (m²/g) | (nm) | (nm) |
| Ni₃CuMg_{1.25}O | CH₄ | 381 | 221 | 0.3409 | 38 |
| 24% Fe/MgO | CO/H₂ (4:1) | 4 | 224 | 0.3391 | 37 |
| 48% Fe/MgO | CO/H₂ (4:1) | 57 | 95 | 0.3374 | 88 |
| 72% Fe/MgO | CO/H₂ (4:1) | 61 | 90 | 0.3371 | 93 |
| 84% Fe/MgO | CO/H₂ (4:1) | 61 | 72 | 0.3369 | 116 |

### Example 5

In this series of experiments the effect of the calcination temperature during the catalyst preparation step on the subsequent growth of “platelet” graphite nanofibers was investigated. In this case, a Ni_{X}Cu_{Z}Mg_{Y}O(x:y=2.4:1)(x:z=4:1) was selected as the catalyst and following calcination at various temperatures the samples were reduced in 10% H₂/He at 1000° C. and then reacted in 60 ml/min CH₄ at 665° C. until the activity dropped below 5%. From the results given in Table 5 below it can be seen that, within experimental error, there is little difference in the subsequent performance of the catalyst provided that the calcination step is carried out between 350 to 1000° C., followed by reduction at 1000° C. When calcinations were performed at 1000° C. the catalyst lifetime for graphite nanofiber formation was enhanced, however, the rate of growth dropped so that the overall yield remained constant.

TABLE 5

| Calcination Temp | % | Lifetime | GNF Yield |
|---|---|---|---|
| (° C.) | CH₄ Conv. | (h) | (g-C/g-Cat) |
| 350 | 30.0 | 44 | 425 |
| 500 | 30.3 | 45 | 456 |
| 750 | 30.0 | 40 | 392 |
| 1000 | 30.5 | 57 | 440 |

### Example 6

In this set of experiments, the effect of the reduction temperature during the catalyst preparation step on the subsequent growth of “platelet” graphite nanofibers was investigated. In this case, a Ni_{X}Cu_{Z}Mg_{Y}O(x:y=2.4:1)(x:z=4:1) was selected as the catalyst and following calcination at 500° C. the samples were reduced in 10% H₂/He at various temperatures and then reacted in 60 ml/min CH₄ at 665° C. until the activity dropped below 5%. From the results shown in Table 6 below it can be seen that while the conversion of CH₄ remained at a constant level the catalyst lifetime exhibited a steady rise with increasing reduction temperature and this resulted in a corresponding increase in the yield of graphite nanofibers.

TABLE 6

| Reduction Temp | % | Lifetime | GNF Yield |
|---|---|---|---|
| (° C.) | CH₄ Conv. | (h) | (g-C/g-Cat) |
| No prior reduction | 30.4 | 27 | 250 |
| 600 | 30.7 | 33 | 301 |
| 700 | 30.5 | 34 | 327 |
| 850 | 30.6 | 43 | 427 |
| 1000 | 30.3 | 45 | 456 |

1. A graphite nanofiber comprised of graphite sheets that are substantially perpendicular to the longitudinal axis of the nanofibers, which nanofibers have: a crystallinity greater than about 95%; average width less than about 75 nm; a surface area greater than 115 m²/g; and wherein the distance between the graphite sheets is from about 0.335 nm to about 0.67 nm.

2. The graphite nanofiber of claim 1 having an average width of less than about 65 nm.

3. The graphite nanofiber of claim 2 having an average width of about 33 to 55 nm.

4. The graphite nanofiber of claim 1 wherein the distance between the graphite sheets is from about 0.335 nm to about 0.40 nm.

5. The graphite nanofiber of claim 1 having a surface area of about 130 m²/g to about 250 m²/g.

6. A process of producing substantially crystalline graphite nanofibers comprised of graphite sheets that are substantially perpendicular to the longitudinal axis of the nanofibers, which nanofibers have: a crystallinity greater than about 95%; average width less than about 75 nm; a surface area greater than 115 m²/g; and wherein the distance between the graphite sheets is from about 0.335 nm to about 0.67 nm, which process comprises reacting methane in the presence of a NiCu/MgO powdered catalyst for an effective amount of time from about 600 to about 800° C., wherein the ratio of Ni to Cu ranges from about 9:1 to about 1:1 and the total Ni to MgO ranges from about 0.6:1 to about 3.6:1.

7. The process of claim 6 wherein the ratio of Ni to Cu ranges from about 4:1 to about 3:2:

8. The process of claim 6 wherein the amount of Ni to MgO ranges from about 1.8:1 to about 3.6:1.

9. The process of claim 8 wherein the amount of Ni to MgO ranges from about 2.4:1.

10. The process of claim 6 wherein the average particles size of the powdered catalyst is from about 50 nm to about 5 microns.

11. The process of claim 10 wherein the average particle size of the powdered catalyst is from about 250 nm to about 1 microns.

12. The process of claim 6 wherein the temperature range is from about 625° C. to about 760° C.

13. The graphite nanofibers of claim 6 wherein the distance between the graphite sheets is from about 0.335 nm to about 0.40 nm.

14. The graphite nanofibers of claim 6 having a surface area of about 130 m²/g to about 250 m²/g.
